(19) United States
(12) Patent Application Publication
(10) Pub. No.: US 2026/0139582 A1
(43) Pub. Date: May 21, 2026

(54) DOWNHOLE INDUCTIVE COMMUNICATION LINK

(71) Applicant: Schlumberger Technology Corporation, Sugar Land, TX (US)

(72) Inventors: Michael Bladon, Calgary (CA); Adam Mewha, Calgary (CA); Peter Donlon, Calgary (CA)

(21) Appl. No.: 19/289,329

(22) Filed: Aug. 4, 2025

Related U.S. Application Data
(60) Provisional application No. 63/722,230, filed on Nov. 19, 2024.

(51) Int. Cl. E21B 47/13; H01Q 1/22; H01Q 7/06

(52) U.S. Cl. CPC E21B 47/13; H01Q 1/22; H01Q 7/06

(57) ABSTRACT

An inductive communication link for use in a bottom hole assembly includes an outer antenna assembly including an outer antenna deployed and sealed in an outer antenna housing, an inner antenna assembly including an inner antenna deployed and sealed in a pin end of an inner antenna housing, wherein the open axial end of the outer antenna housing is configured to receive the pin end of the inner antenna housing such that the inner antenna is inductively linked with the outer antenna.

### CROSS REFERENCE TO RELATED APPLICATIONS

This application claims priority to and the benefit of U.S. Provisional Patent Application No. 63/722230, filed on Nov. 19, 2024, which is hereby incorporated by reference in its entirety.

### BACKGROUND

Downhole drilling operations commonly make use of sensor data obtained from a large number of sensors deployed in the drill string. Such sensors are well known and may include, for example, various measurement while drilling (MWD) and logging while drilling (LWD) sensors. Moreover, it is often advantageous to deploy a subset of these sensors as close as possible to (or even in) the drill bit. For example, rotary steerable systems (RSS) commonly include navigation sensors, formation evaluation sensors, and/or diagnostic sensors deployed close to the bit.

Downhole sensor data is commonly transmitted to the surface (while drilling) via a telemetry link (e.g., a mud pulse or mud siren telemetry link or an electromagnetic telemetry link) that may be located in the bottom hole assembly. Owing to space and other constraints, it is not always possible to provide a hardwire connection between the sensors and the telemetry link. While inductive communication links are known, such inductive links commonly require precise positioning of the corresponding inductive elements. Moreover, inductive communication links can be prone to damage in the harsh downhole environment. There is a need in the industry for an improved inductive communication link, particularly one that is suitable for drilling operations in which the one or more of the downhole tools is assembled in the field (e.g., on the rig floor).

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling system incorporating a disclosed inductive communication link.

FIG. 2 depicts one example embodiment of the inductive communication link shown on FIG. 1.

FIGS. 3A, 3B, and 3C (collectively FIG. 3) depict an example embodiment of an outer antenna assembly suitable for use in the inductive communication link shown on FIG. 2.

FIGS. 4A and 4B (collectively FIG. 4) depict an example embodiment of an inner antenna assembly suitable for use in the inductive communication link shown on FIG. 2.

FIG. 5 depicts an alternative inner antenna assembly including integrated control electronics.

FIGS. 6A, 6B, and 6C (collectively FIG. 6) depict the inductive communication link shown on FIG. 2 made up with the inner antenna assembly located at three distinct relative axial positions with respect to the outer antenna assembly.

FIG. 7 depicts an example two-way electromagnetic telemetry link between the surface and a downhole tool.

FIG. 8 depicts a flow chart of one example disclosed method for downlinking a command from the surface to a downhole tool.

### DETAILED DESCRIPTION

An inductive communication link for use in a bottom hole assembly is disclosed. In one example embodiment the inductive communication link includes an outer antenna assembly including an outer antenna deployed and sealed in an outer antenna housing. The outer antenna assembly is coupled to a first downhole tool in the BHA and includes an open axial end. The communication link further includes an inner antenna assembly including an inner antenna deployed and sealed in a pin end of an inner antenna housing. The inner antenna assembly is coupled to a second downhole tool in the BHA. The open axial end of the outer antenna housing is configured to receive the pin end of the inner antenna housing such that the inner antenna is inductively linked with the outer antenna. In example embodiments an axial length of the outer antenna may be at least 25 mm greater than and/or at least twice the axial length of the inner antenna.

In another embodiment, a method for downlinking commands, data, and/or other information from the surface to a downhole tool is disclosed. In one example embodiment, the method includes transmitting the information from the surface location to a measurement while drilling tool in the drill string using an electromagnetic telemetry link and transmitting the information from the measurement while drilling tool to the rotary steerable tool via the disclosed inductive communication link.

The disclosed inductive communication link may provide numerous advantages. For example, the communication link may advantageously provide a higher bandwidth connection to the surface, thereby increasing the speed and amount of data that can be transmitted between surface and downhole tools. One significant benefit is reduced drilling time. Moreover, as described in more detail below, the disclosed communication link provides for significant positional tolerance between the inner and outer antennas, thereby enabling rig site assembly of various downhole tools and tool strings.

Furthermore, the disclosed inductive communication link tends to be advantageously mechanically robust. As described in more detail below, the sensitive antenna components may be sealed from the downhole environment such that each side of the link may be directly exposed to drilling conditions with or without the corresponding mating part. For example, the sensitive antenna components may be deployed and sealed in corresponding protective nonmagnetic metallic housings. This may promote improved utilization, operational flexibility as well as protection during shipping, handling and tool buildout on a rig floor.

Still further, the inductive communication link tends to be suitable for low power inductive communications (e.g., a reliable inductive link may generally be established at power requirement of less than 1 W). This low power requirement may further improve reliability by reducing the system's dependence on sufficient flow to generate power using turbines, especially at times when other subsystems have high power demand such as when steering in difficult conditions. These and other advantages are described in more detail below.

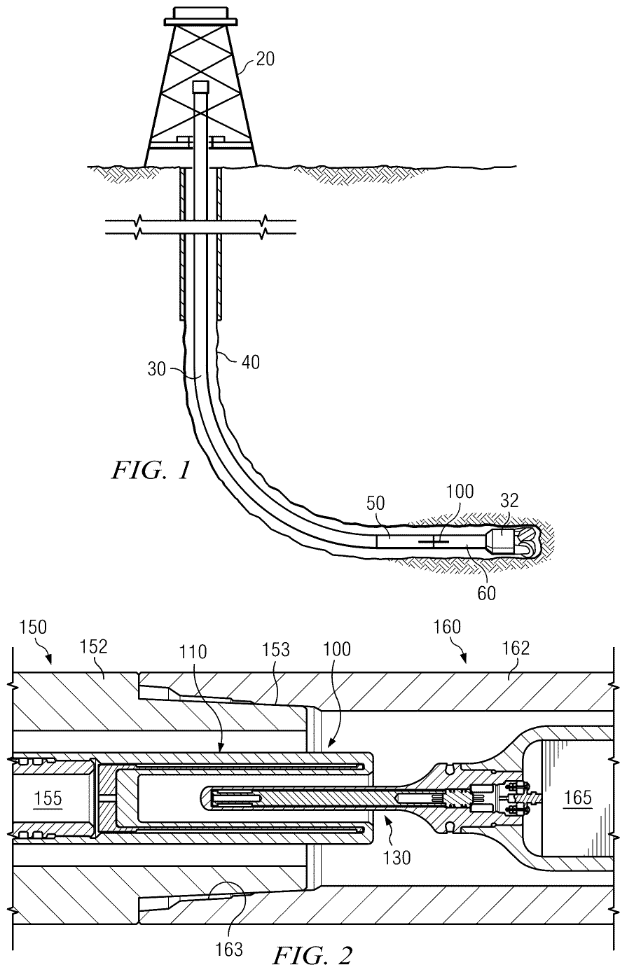

FIG. 1 depicts a schematic of a drilling rig 20 including a drill string 30 with a disclosed inductive communication link 100 located between first and second downhole tools 50, 60 disposed within a wellbore 40. The drilling rig 20 may be deployed in either onshore or offshore applications (an onshore application is depicted). In this type of system, the wellbore 40 may be formed in subsurface formations by rotary and/or slide drilling techniques in a manner that is well-known to those of ordinary skill in the art (e.g., via well-known directional drilling techniques).

As is known to those of ordinary skill, in a common rotary drilling operation, the drill string 30 may be rotated at the surface to rotate the drill bit and drill the wellbore 40. The BHA (and bit) may alternatively (or additionally) be rotated via a downhole mud motor. During drilling a pump may deliver drilling fluid to the interior of the drill string 30 thereby causing the drilling fluid to flow downwardly through the drill string 30. The drilling fluid exits the drill string 30, e.g., via ports in a drill bit 32, and then circulates upwardly through the annulus region between the outside of the drill string 30 and the wall of the wellbore 40. In this known manner, the drilling fluid lubricates the drill bit 32 and carries formation cuttings up to the surface. The drilling fluid may further power a mud motor in example embodiments.

In the illustrated embodiment, the inductive communication link 100 may be deployed in a bottom hole assembly (BHA) between substantially any suitable downhole tools, for example, between an MWD tool and an RSS or between an MWD tool and an LWD tool, and may be configured to provide two-way (bidirectional) communication between the tools 50, 60. In certain advantageous embodiments, the inductive communication link 100 may be deployed between an MWD tool and an LWD or RSS tool and may be configured to transmit data and/or commands (referred to broadly herein as information) back and forth between the tools as described in more detail below.

Suitable LWD tools may be configured to measure one or more properties of the formation through which the wellbore 40 penetrates, for example, including resistivity, density, porosity, sonic velocity, gamma ray counts, and the like. A suitable MWD tool may be configured to measure one or more properties of the wellbore 40 as it is drilled or at any time thereafter (e.g., when tripping). The physical properties may include pressure, temperature, wellbore caliper, wellbore trajectory (attitude), and the like. A suitable MWD tool may further include a unidirectional telemetry system such as a mud-pulse or mud-siren telemetry system and/or a bidirectional telemetry system such as an electromagnetic telemetry system having an electromagnetic transceiver (or distinct transmitter and receiver elements) or a bi-directional pulse telemetry system including a mud pulse/siren uplink and flow modulation downlink.

Those of ordinary skill will readily recognize that RSS tools include steering elements that may be actuated to control and/or change the direction of drilling the wellbore 40. In embodiments employing a rotary steerable tool, substantially any suitable rotary steerable tool configuration may be used. For example, the PowerDrive Xceed makes use of an internal steering mechanism that will not require contact with the wellbore wall and enables the tool body to fully rotate with the drill string. The PowerDrive X5, X6, and Orbit make use of mud actuated blades (or pads) that contact the wellbore wall. Extension of the blades (or pads) is rapidly and continually adjusted as the system rotates in the wellbore to steer the direction of drilling. The POWERDRIVE ARCHER® makes use of a lower steering section joined at a swivel with an upper section. PowerDrive RSS tools may include an instrument housing that rotates with the drill string or may alternatively be roll-stabilized such that the deployed sensors and electronics remain substantially stationary (in a bias phase) or rotate slowly with respect to the wellbore (in a neutral phase). While example embodiments are described above (and elsewhere herein) with respect to various MWD, LWD, and RSS embodiments, it will be appreciated that the disclosed embodiments are not so limited.

It will be appreciated that in many drilling operations, certain ones of the downhole drilling tools may be assembled at the wellsite. The components to be assembled are commonly shipped to the drilling location from a number of suppliers and corresponding locations. For example, an MWD tool may be assembled on-site from subcomponents (such as a telemetry transmitter, a battery pack, directional sensors, etc.) that are obtained from one or more locations. Once assembled, the total assembly (having a length of up to or even exceeding 10 m) is moved to the rig floor, raised vertically, and lowered into a nonmagnetic MWD collar that has been previously threaded into the tool below (e.g., to the top sub of an RSS tool). For example, the MWD tool may land on a ledge in a gap sub and then be secured in place. MWD collars are commonly obtained from third-party rental suppliers and may be reused and sometimes have re-cut threads prior to re-use.

It will be understood that in such operations (and others in which tools are assembled in the field), assembling an inductive communication link between the upper and lower tools (e.g., the MWD and RSS tools) presents a difficult challenge. For example, achieving precise axial spacing of the inductive coupling elements is impractical (or even impossible) given the nature of the onsite assembly and reuse of the drill collars. Moreover, post assembly verification by rig personnel that the inductive coupling elements are properly spaced (and adjustment if necessary) presents further difficulties. There is a need in the industry for an improved inductive communication link that is suitable for onsite assembly of downhole tools.

FIG. 2 depicts one example embodiment of the inductive communication link 100 shown on FIG. 1 deployed between first and second downhole tools 150, 160. In the depicted embodiment, the inductive communication link 100 includes an outer antenna assembly 110 deployed in the first downhole tool 150 and an inner antenna assembly 130 deployed in the second downhole tool 160. In the example embodiment depicted, the outer antenna assembly 110 may be deployed proximate a pin end 153 of collar 152 in the first downhole tool 150 and the inner antenna assembly 130 may be deployed proximate to a box end 163 of collar 162 in the second downhole tool 160. It will be appreciated that collar 152 may be (or may also be thought of as being) a top sub portion of second downhole tool 160 and may be coupled with the first downhole tool. The disclosed embodiments are not limited in these regards.

With continued reference to FIG. 2, the outer antenna assembly 110 may be mechanically and rotationally coupled with (and electronically connected with electronic components in) a first tool housing 155. The inner antenna assembly 130 may be mechanically and rotationally coupled with (and electronically connected with electronic components in) a second tool housing 165. In example embodiments in which the second downhole tool 160 is an RSS tool, the second tool housing may remain substantially rotationally stationary with respect to the wellbore (or the reference frame of the Earth) such that the inner antenna assembly may rotate with respect to the outer antenna assembly.

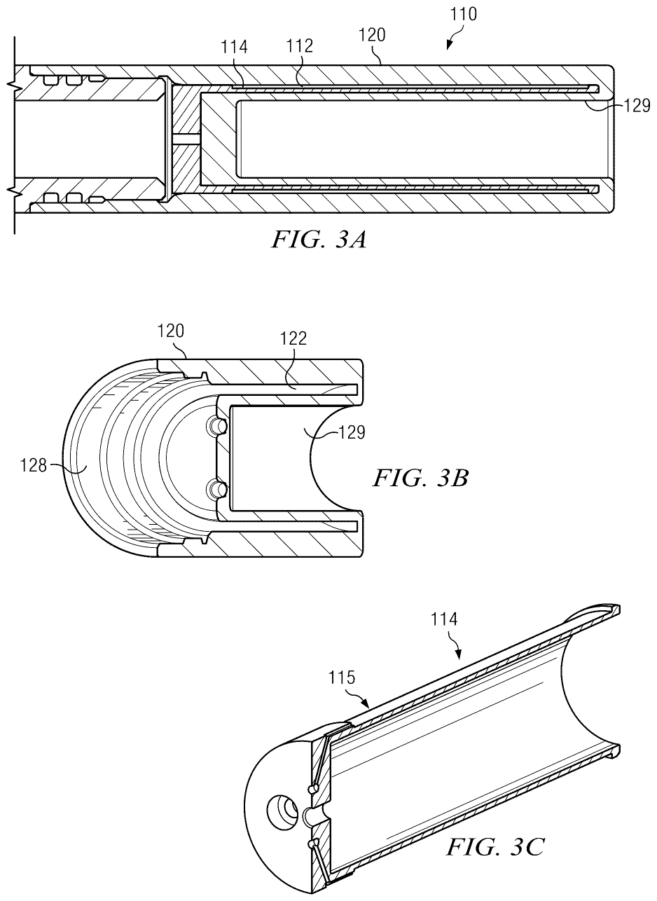

With further reference now to FIGS. 3A, 3B, and 3C (collectively FIG. 3) and continued reference to FIG. 2, one example embodiment of the outer antenna assembly 110 is described in more detail. As depicted, outer antenna windings 112 may be fully enclosed in (e.g., sealed in) an outer antenna housing 120 that is configured to isolate the antenna 112 from external pressure and drilling fluid and thereby protect the outer antenna from the severe downhole conditions. The antenna windings 112 are wound about a groove 115 (a section having a reduced outer diameter) in an outer antenna bobbin 114. The outer antenna bobbin 114 is sized and shaped for insertion into a corresponding bobbin slot 122 in the outer antenna housing 120. The antenna housing 120 further includes first and second axially opposed open ends 128, 129. The first open end 128 is sized and shaped to sealingly engage an outer surface of the first tool housing 155. Sealing engagement with the housing 155 is intended to isolate the bobbin slot 122 (and the outer antenna 112) from drilling fluid in the collar 152. The second open end 129 is sized and shaped to receive the inner antenna assembly 130 when the tool string is made up (when the first and second tools 150, 160 are fully made up and connected to one another).

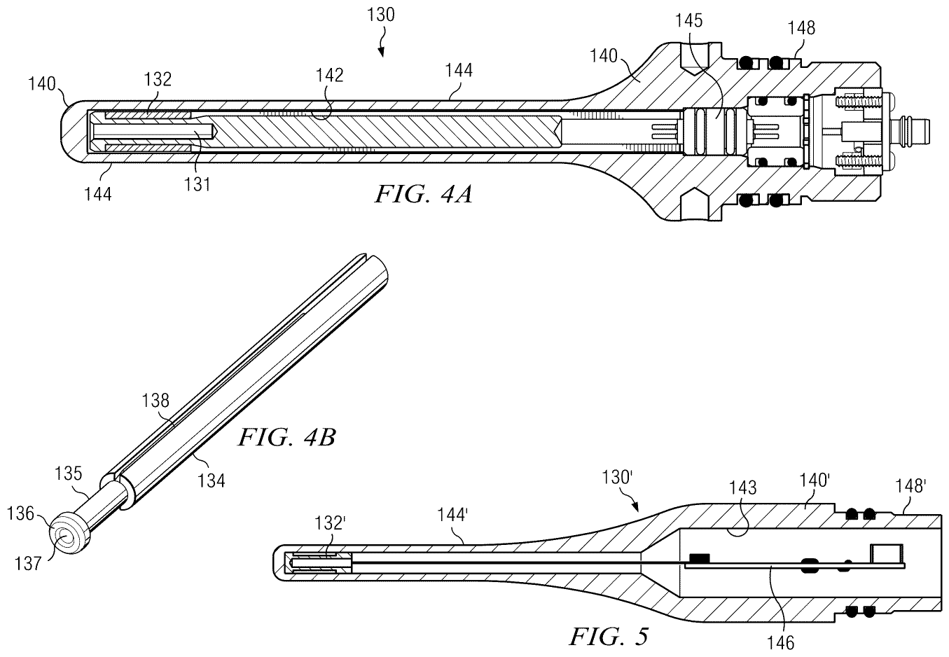

With further reference now to FIGS. 4A and 4B (collectively FIG. 4) and continued reference to FIG. 2, one example embodiment of the inner antenna assembly 130 is described in more detail. As depicted, inner antenna windings 132 may be fully enclosed in an inner antenna housing 140 that is configured to isolate (seal) the antenna windings 132 from external pressure and drilling fluid and thereby protect the inner antenna 132 from severe downhole conditions. The antenna windings 132 are wound about a groove 135 (a section having a reduced outer diameter) in an inner antenna bobbin 134. In the depicted example embodiment, the groove 135 is located proximate to an axial end 136 of the bobbin 134. The axial end of the bobbin 134 further includes a bore 137 configured to receive a cylindrical magnetic core 131 (e.g., a ferrite core). The example bobbin 134 depicted still further includes a channel 138 for routing the antenna wires from the winding 132 to the second downhole tool housing 165. The inner antenna bobbin 134 may be sized and shaped for insertion into a corresponding bore 142 in the inner antenna housing 140. A pressure bulkhead 145 secures the inner antenna bobbin 134 in the bore 142 and sealingly engages the bore 142. The pressure bulkhead 145 may further prevent invasion of drilling fluid into the second tool housing 165 if the inner antenna assembly is damaged. The depicted inner antenna housing 140 may further include a plug end 148 that is sized and shaped to sealingly engage a corresponding open end of the second tool housing 165, thereby isolating the housing 165 from drilling fluid in the collar 162.

Turning now to FIG. 5, one alternative inner antenna assembly embodiment 130′ is depicted. Inner antenna assembly 130′ is similar to inner antenna assembly 130 in that it includes inner antenna windings 132′ enclosed in the pin end 144′ of an inner antenna housing 140′ that is configured to isolate (seal) the antenna windings 132′ from external pressure and drilling fluid and thereby protect the inner antenna 132′ from severe downhole conditions. The housing 140′ may include a plug end 148′ that is sized and shaped to sealingly engage a corresponding open end of the second tool housing 165, thereby isolating the housing 165 from drilling fluid in the collar 162 (as described above with respect to FIG. 4). The inner antenna assembly embodiment 130′ further include integrated control electronics 146 (e.g., a printed circuit board including a modem or other communication electronics) deployed in an enlarged opening or bore 143 in the housing 140′. The control electronics may be in electronic communication (e.g., via a hard wire connection not shown) with a controller in the second downhole tool 160.

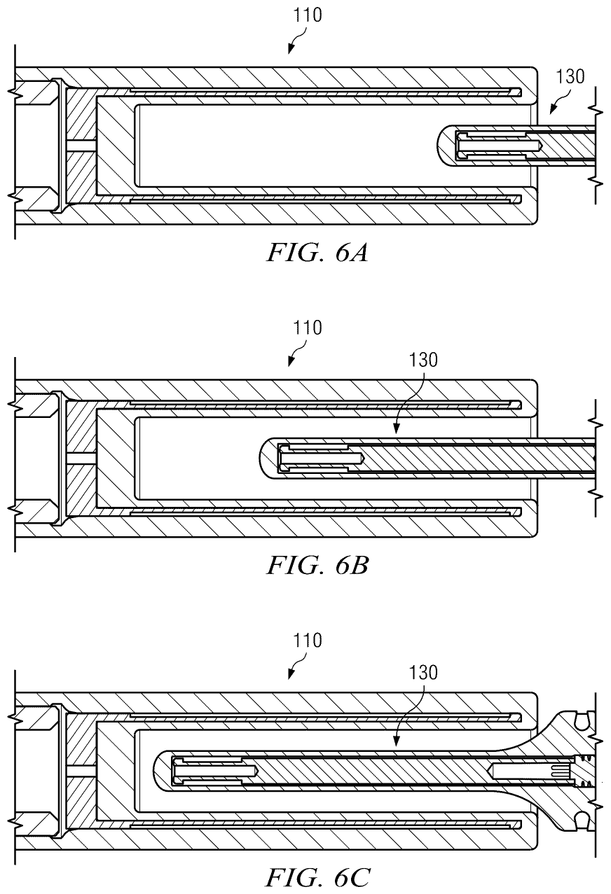

With further reference now to FIGS. 6A, 6B, and 6C (collectively FIG. 6), inductive communication link 100 is shown made up with the inner antenna assembly 130 located at three distinct relative axial positions with respect to the outer antenna assembly 110. It has been found that the inductive communication link 100 advantageously functions properly as long as the inner antenna 132 is located within the outer antenna 112. In FIG. 6A, the inner antenna 132 is located at a downhole axial end of the outer antenna assembly (proximate opening 129) such that the inner antenna 132 is located within the downhole end of the outer antenna 112 (right side of drawing). In FIG. 6B, the inner antenna 132 is located at the approximate axial midpoint of the outer antenna 112. In FIG. 6C, the inner antenna assembly 130 is fully inserted into the outer antenna assembly 110 such that the inner antenna 132 is located within the uphole end of the outer antenna 112 (left side of drawing).

The disclosed inductive communication link 100 has been found to function properly in each of the configurations shown in FIGS. 6A, 6B, and 6C. It will therefore be appreciated that the disclosed inductive communication link 100 has a large axial tolerance (i.e. can withstand or tolerate a range of relative axial positions of the outer and inner antennas 112, 132). In example embodiments, the disclosed inductive communication link 100 may have an axial tolerance of at least 25 mm (e.g., at least 50 mm or at least 75 mm).

With continued reference to FIGS. 2-6, the large axial tolerance may be achieved by configuring the outer antenna 112 to have an axial length that is greater than an axial length of the inner antenna 132. In certain advantageous embodiments, the outer antenna 112 may have an axial length that is at least 25 mm (e.g., at least 50 mm or at least 75 mm) greater than the axial length of the inner antenna 132. Moreover, the axial length of the outer antenna 112 may additionally and/or alternatively be at least two times the axial length of the inner antenna 132 (e.g., at least three times, at least four times, or even at least five times the axial length of the inner antenna). By axial antenna length it may be meant the axial lengths of the grooves 115, 135 that receive the antenna windings 112, 132 such that the axial length of groove 115 may be greater than the axial length of groove 135 (e.g., at least two times, at least three times, at least four times, or even at least five times the axial length of groove 135).

With still further reference to FIGS. 2-6, the large axial tolerance may be achieved by deploying the inner antenna 132 proximate to an axial end 136 of bobbin 134. The inner housing 140 includes a pin end 144 having a reduced outer diameter sized and shaped for insertion into the open axial end 129 of the outer antenna assembly 110. The inner housing 140 and pin end 144 include an elongated bore 142 that is sized and shaped to receive the bobbin 134. A large axial tolerance may be achieved, for example, by configuring the bobbin 134 and/or the pin end 144 to have an axial length that is at least 25 mm greater than the axial length of the inner antenna 132 (e.g., greater than 50 mm or greater than 75 mm) and/or at least twice the axial length of the inner antenna 132 (e.g., at least three times, at least four times, or even at least five times the axial length of the inner antenna). As stated above, by axial length of the inner antenna, it may be meant the axial length of the groove 115 in the bobbin 114. By axial length of the pin end 144 it is meant the axial length of the reduced diameter section (the finger or pin) of the inner housing 140.

It will be appreciated that the large axial tolerance provided by the disclosed inductive communication link 100 may advantageously enable the axial positions of the antenna components to vary so that precise BHA lengths or adjustment of extenders are not required during BHA assembly. It will be further appreciated that the disclosed inductive communication link 100 may further advantageously provide lateral position and/or angle tolerance such that bending the BHA (and the inductive communication link) through a high dogleg wellbore will not interrupt electromagnetic communications. Such lateral tolerance may be achieved, for example, by providing a sufficiently large radial gap (clearance) between the outer diameter of the inner housing 140 and the inner diameter of the outer housing 120. In example embodiments, the radial gap (or clearance) between the inner and outer housings 140, 120 may be greater than about 2 mm, (e.g., greater than about 3 mm, greater than about 4 mm, or greater than about 5 mm).

It will be appreciated that the disclosed inductive communication link will not include any mechanical seals between the antenna assemblies 110, 130 such that both assemblies are exposed to drilling fluid and pressure during a drilling operation. As described above, the outer and inner antenna windings 112, 132 are advantageously fully enclosed and sealed within corresponding outer and inner housings 120, 140. The housing may be fabricated from substantially any suitable material having sufficient strength to withstand the severe downhole conditions (including pressure and vibration) as well as low electromagnetic attenuation in the frequency range of the electromagnetic carrier signal (e.g., from about 500 Hz to about 20 kHz or from about 1 kHz to about 10 kHz). In example embodiments, the outer and inner housings 120, 140 may be advantageously fabricated from a metallic (metal or metal containing alloy) material such as a nonmagnetic steel or an Inconel alloy.

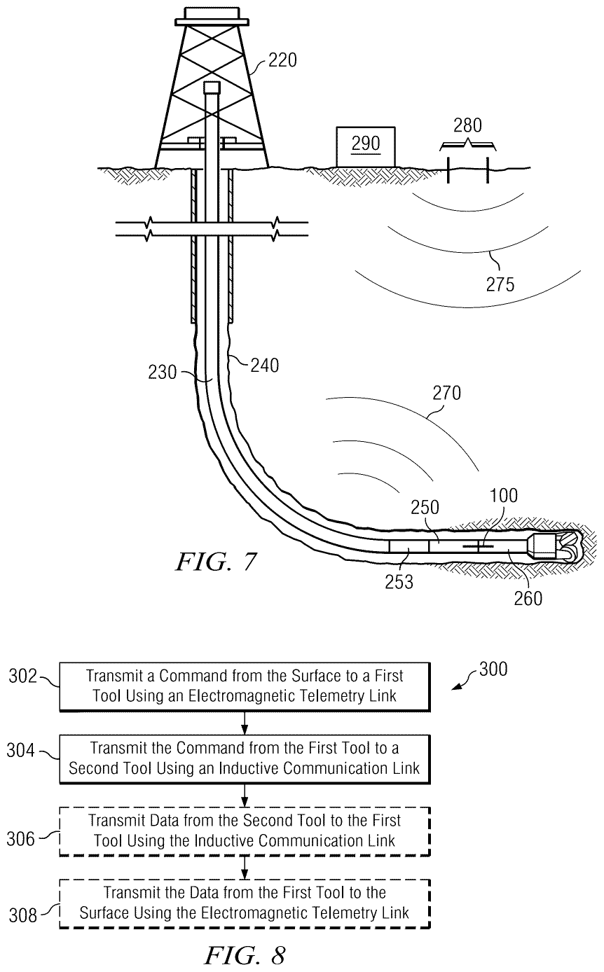

FIG. 7 depicts an example bidirectional telemetry link between the surface and a downhole tool that makes use of the disclosed inductive communication link 100. In this example embodiment, the bidirectional telemetry link includes electromagnetic uplink and downlink, however, the discussed embodiments are not limited in this regard. In FIG. 7, a drilling rig 220 includes a drill string 230 with the disclosed inductive communication link 100 located between first and second downhole tools 250, 260 disposed within a wellbore 240. In advantageous embodiments, the first downhole tool 250 is an MWD tool and the second downhole tool 260 is an RSS tool. In the depicted example embodiment, the rig employs an electromagnetic telemetry system 290 that communicates with an electromagnetic telemetry tool 253 in the string 230 (e.g., in or associated with the first downhole tool 250). The system 290 enables bidirectional communication between the BHA and the surface.

During a drilling operation data and/or commands (referred to broadly herein as information) may be communicated between the surface and the second downhole tool 260 via the telemetry system 290 and inductive communication link 100. For example, data may be transmitted from the second downhole tool 260 to the first downhole tool 250 via the inductive communication link 100 and then relayed to the surface via the telemetry tool 253. Moreover, information may be communicated from the surface to the first downhole tool 250 via the telemetry system 290 and then relayed to the second downhole tool 260 via the inductive communication link 100.

While the disclosed embodiments are not limited in this regard, the electromagnetic telemetry tool 253 may include, for example, a transceiver having an electric dipole antenna formed by an insulated gap between conductive drill collar segments on the drill string 230 or by a toroid deployed about an outer surface of a drill collar in the string 230. The telemetry tool 253 may be configured to transmit an encoded electromagnetic signal (depicted schematically at 270) that may be received using a surface transceiver 280 (e.g., one or more metallic stakes inserted into the ground). The surface transceiver 280 may also be configured to transmit an encoded electromagnetic signal 275 that may be received at the electromagnetic telemetry tool 253. In this way the telemetry system 290 may enable bidirectional communication between the surface and the BHA.

FIG. 8 depicts a flow chart of one example method 300 for downlinking a command from the surface to a downhole tool (such as an RSS tool). The method includes transmitting a command data from the surface to a first downhole tool at 302 using an electromagnetic telemetry link (e.g., link 290 in FIG. 6). The command data may then be transmitted from the first downhole tool to a second downhole tool at 304 using the disclosed bidirectional inductive communication link (e.g., link 100 in FIGS. 2-6). It will be appreciated that the transmitted command may include substantially any suitable command and may also include data or other information. For example, the command or data may include a command to change an RSS tool setting or a direction of drilling. The command and/or data may additionally (or alternatively) include a modification to the well plan, for example, based on MWD/LWD data and/or other surface measurements made while drilling. The disclosed bidirectional link may advantageously provide improved bandwidth for downlinking such commands/data/information to the second tool. With continued reference to FIG. 8, the method 300 may further optionally include transmitting data from the second downhole tool to the first downhole tool at 306 using the bidirectional inductive communication link and transmitting the data from the first downhole tool to the surface at 308 using the electromagnetic telemetry link.

The disclosed embodiments may advantageously significantly reduce the time required to transmit a command from the surface to a downhole tool (such as an RSS tool). For example, command transmission generally requires less than 30 seconds and requires no changes to the drilling parameters (e.g., drilling fluid pressure and a drill string rotation rate). This is in comparison to current command downlinking methods that require changing the drilling parameters, which in turn reduce the rate of penetration. Given that many commands may be transmitted downhole during a drilling operation, the disclosed method may advantageously reduce the total drilling time. The disclosed embodiments may further provide timely confirmation that transmitted commands have been properly received.

Although a downhole inductive communication link has been described in detail, it should be understood that various changes, substitutions and alternations can be made herein without departing from the spirit and scope of the disclosure as defined by the appended claims.

What is claimed is:

1. An inductive communication link for use in a bottom hole assembly, the inductive communication link comprising:
an outer antenna assembly including an outer antenna deployed and sealed in an outer antenna housing, the outer antenna assembly coupled to a first downhole tool, the outer antenna housing including an open axial end;
an inner antenna assembly including an inner antenna deployed and sealed in a pin end of an inner antenna housing, the inner antenna assembly coupled to a second downhole tool; and
wherein the open axial end of the outer antenna housing is configured to receive the pin end of the inner antenna housing such that the inner antenna is inductively linked with the outer antenna.

2. The inductive communication link of claim 1, wherein an axial length of the outer antenna is at least two times an axial length of the inner antenna.

3. The inductive communication link of claim 1, wherein:
the inner antenna is proximate to an axial end of the pin end; and
an axial length of the pin end is at least two times an axial length of the inner antenna.

4. The inductive communication link of claim 1, wherein an axial length of the outer antenna is at least 25 mm greater than an axial length of the inner antenna.

5. The inductive communication link of claim 1, wherein:
the inner antenna is proximate to an axial end of the pin end; and
an axial length of the pin end is at least 25 mm greater than an axial length of the inner antenna.

6. The inductive communication link of claim 1, wherein the outer antenna includes a winding that is wound about a reduced outer diameter groove in an outer bobbin, the outer bobbin deployed and sealed in a corresponding bobbin groove in the outer antenna housing.

7. The inductive communication link of claim 1, wherein the inner antenna includes a winding that is wound about a reduced outer diameter groove in an inner bobbin, the inner bobbin deployed and sealed in a bore in the pin end, the inner antenna assembly further including a magnetic core deployed in a bore in the inner bobbin internal to the inner antenna winding.

8. The inductive communication link of claim 1, wherein the inner antenna assembly further includes integrated control electronics sealed in the inner antenna housing.

9. The inductive communication link of claim 1, wherein a gap between an outer diameter of the pin end and an inner diameter of the outer antenna housing is in fluid communication with drilling fluid in the first and second downhole tools.

10. The inductive communication link of claim 1, wherein the outer antenna assembly is disposed to rotate with respect to the inner antenna assembly.

11. A method for transmitting information from a surface location to a rotary steerable tool in a drill string, the method comprising:
transmitting the information from the surface location to a measurement while drilling tool in the drill string using an electromagnetic telemetry link;
transmitting the information from the measurement while drilling tool to the rotary steerable tool via an inductive communication link; and
wherein the inductive communication link includes an outer antenna deployed about an inner antenna, the outer antenna deployed and sealed in an outer antenna housing having an open axial end, the inner antenna deployed and sealed in a pin end of an inner antenna housing, the pin end disposed in the open end of the outer antenna assembly such that the outer antenna and the inner antenna are inductively coupled.

12. The method of claim 11, further comprising:
transmitting data from the rotary steerable tool to the measurement while drilling tool via the inductive communication link; and
transmitting the data from the measurement while drilling tool to the surface using the electromagnetic telemetry link.

13. The method of claim 11, wherein:
an axial length of the outer antenna is at least two times an axial length of the inner antenna;
the inner antenna is proximate to an axial end of the pin end; and
an axial length of the pin end is at least two times the axial length of the inner antenna.

14. The method of claim 11, wherein:
the outer antenna includes a winding that is wound about a reduced outer diameter groove in an outer bobbin, the outer bobbin deployed and sealed in a corresponding bobbin groove in the outer antenna housing;
the inner antenna includes a winding that is wound about a reduced outer diameter groove in an inner bobbin, the inner bobbin deployed and sealed in a bore in the pin end, the inner antenna assembly further including a magnetic core deployed in a bore in the inner bobbin internal to the inner antenna winding; and
a gap between an outer diameter of the pin end and an inner diameter of the outer antenna housing is in fluid communication with drilling fluid in the measurement while drilling tool and the rotary steerable tool.

15. The method of claim 11, wherein the inductive communication link is configured to transmit the information at a frequency in a range from about 500 Hz to about 20 kHz.

16. A downhole tool string comprising:
a measurement while drilling tool coupled to a rotary steerable tool;
the measurement while drilling tool including an outer antenna assembly having an outer antenna deployed and sealed in an outer antenna housing, the outer antenna housing having an open axial end;
the rotary steerable tool including an inner antenna assembly having an inner antenna deployed and sealed in an inner antenna housing, the inner antenna housing including a pin end, the inner antenna proximate to an axial end of the pin end;
at least a portion of the pin end deployed in the open axial end such that the inner antenna is inductively linked with the outer antenna; and
wherein an axial length of the outer antenna is at least 25 mm greater than and at least twice an axial length of the inner antenna.

17. The downhole tool string of claim 16, wherein:
an axial length of the pin end is at least 25 mm longer than the axial length of the inner antenna; and
the axial length of the pin end is at least twice the axial length of the inner antenna.

18. The downhole tool string of claim 16, wherein the outer antenna includes a winding that is wound about a reduced diameter groove in an outer bobbin, the outer bobbin deployed and sealed in a bobbin groove in the outer antenna housing.

19. The downhole tool string of claim 16, wherein the inner antenna includes a winding that is wound about a reduced diameter groove in an inner bobbin, the inner bobbin deployed and sealed in a bore in the pin end, the inner antenna assembly further including a magnetic core deployed in a bore in the inner bobbin internal to the inner antenna winding.

20. The downhole tool string of claim 16, wherein a radial gap between an outer surface of the pin end and surface of the outer antenna housing is in fluid communication with drilling fluid in the downhole tool string.
